(19) United States
(12) Patent Application Publication
(10) Pub. No.: US 2007/0044856 A1
(43) Pub. Date: Mar. 1, 2007

(54) Diverter valve for water systems

(75) Inventor: David Bonior, Athens, TN (US)

Correspondence Address: PITTS AND BRITTIAN P C, P O BOX 51295, KNOXVILLE, TN, 37950-1295, US

(73) Assignee: Specialty Plastics Applications, LLC, Las Vegas, NV (US)

(21) Appl. No.: 11/216,188

(22) Filed: Aug. 31, 2005

(51) Int. Cl. F16K 11/085

(52) U.S. Cl. 137/625.47

(57) ABSTRACT

An apparatus for diverting water flow between a single port and at least a pair of ports. The diverter valve includes a single port on one side of a valve body and a pair of ports on the opposite side of the cylindrical valve body. The diverter member inside the valve body rotates between two positions when an operator is moved. At either of the two positions, the diverter member aligns one of a pair of openings with one of the pair of ports, thereby allowing fluid to flow between the single port and one of the pair of ports. In various embodiments, the pair of openings are positioned such that, between the two positions, there is no flow or limited flow through one or both of the pair of ports.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to diverter valve for a fluid system. More particularly, this invention pertains to valve that diverts water from one flow path to another flow path, while minimizing the back pressure when changing from one flow path to another. Such a diverter valve is used in pools, spas, hot tubs, bathtubs to divert water flow from the pumps to the jets.

2. Description of the Related Art

Diverter valves direct water from one or more pumps to different groupings of jets in pools, spas, hot tubs, and bathtubs. The prior art includes several types of diverter valves. For example, U.S. Pat. No. 4,800,046, issued to Malek, et al., on Jan. 24, 1989, titled “Water jet aerator with diverter valve,” and U.S. Pat. No. 4,218,784, issued to Richards on Aug. 26, 1980, titled “Dual-purpose diverter valve,” disclose diverter valves for either air or air/water control for pools and spas.

U.S. Pat. No. 4,470,429, issued to Johnson on Sep. 11, 1984, titled “Three-way valve,” discloses a generally cylindrical receptacle or body 12 with three ports, or hubs, 14, 16, 18 offset around the circumference of the body 12. A rotating assembly with a closure plug 22 is within the cylindrical body 12 and serves to selectively block one of the two outlet ports. With the disclosed three-way valve, at least one of the outlet ports 16, 18 is located 90° from the inlet 14.

U.S. Pat. No. 4,635,674, issued to Bajka on Jan. 13, 1987, titled “Diverter valve assembly and method,” discloses a rotary diverter valve includes one water inlet 23a and two selectable outlets 23b, 23c. Inside the housing 22 is a diverter member 26 that includes a seal assembly 31. The Bajka patent states: “In order to maintain the high pressure seal, seal assembly 31 does apply a substantial pressure between diverter member 26 and housing 22.” Further, the Bajka patent teaches that “it is necessary for the smooth and reliable rotation of diverter member 26 within housing 22 for the valve to be lubricated along interior surface 29.” With the disclosed three-way valve, at least one of the outlet ports 23b, 23c is located 120° from the inlet 23a.

Another type of prior art diverter valves include those that have an inlet at the bottom and two selectable outlets located at opposite sides. This type of diverter valve redirects the water flow 90 degrees as the water flows through a turn from the inlet to the outlet. The sharp bend, or turn, results in a pressure drop, in addition to causing turbulent flow and noise. Additionally, the typical prior art diverter valve has a manual actuator at the top of the valve. With the inlet at the bottom of the valve, the water entering the valve strikes the top of the valve, where the operator mechanism is located.

### BRIEF SUMMARY OF THE INVENTION

According to one embodiment of the present invention, a diverter valve is provided. The diverter valve has one single port on one side of the valve and two ports on the opposite side of the valve. The valve includes a diverter member and a valve body. The diverter member is sealed inside the valve body with a cap. A shaft attached to the diverter member protrudes through the cap and has a handle, or operator, attached. The operator rotates the diverter member within the valve body between two positions. At either of the two positions, the diverter member aligns one of a pair of openings with one of the pair of ports, thereby allowing fluid to flow between the single port and one of the pair of ports. In various embodiments, the pair of openings are positioned such that, between the two positions, fluid flows through both of the pair of ports. In various embodiments, the diverter member is rotated by moving a handle between two positions or by a motor or other rotary mechanism.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of a diverter valve;

FIG. 2 is a perspective view of one embodiment of a diverter member;

FIG. 3 is a front view of one embodiment of the diverter member showing a pair of round openings;

FIG. 4 is a rear view of one embodiment of the diverter member showing a rectangular opening;

FIG. 5 is a cross-sectional view of the diverter valve; and

FIG. 6 is a cross-sectional view of the bottom of the diverter valve.

### DETAILED DESCRIPTION OF THE INVENTION

An apparatus for diverting water flow is disclosed. The apparatus is generally shown as item 100 on the figures. The illustrated diverter valve 100 is a two position valve with a single port 104 switchable to one of two ports 106.

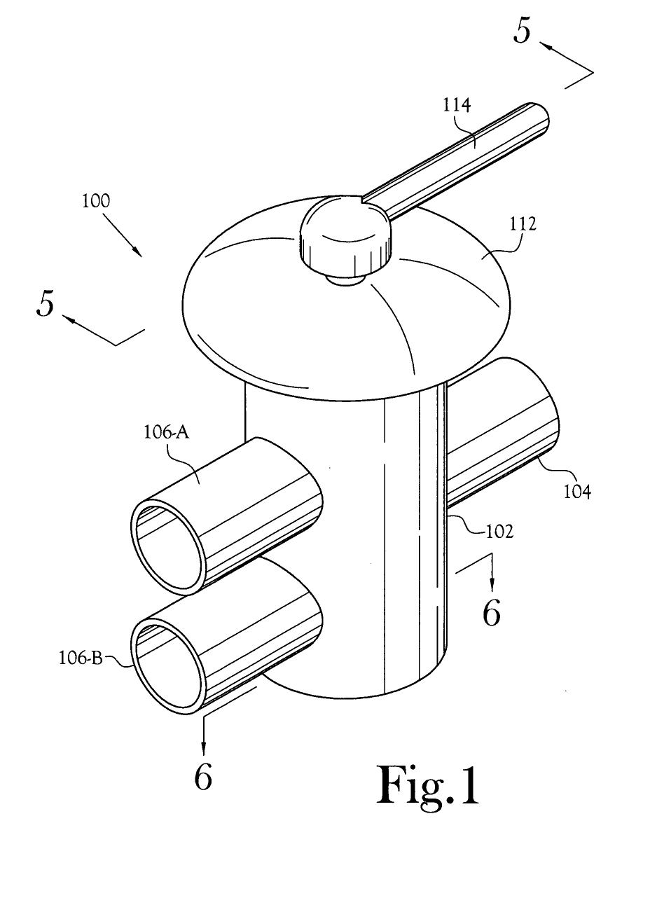

FIG. 1 illustrates a perspective view of one embodiment of a diverter valve 100. The valve 100 has a valve body 102 with one inlet port 104 and two outlet ports 106-A, 106-B. Those skilled in the art will recognize that the direction of water flow relative to the valve 100 is immaterial, for example, in another embodiment the valve body 102 has two inlet ports 106-A, 106-B and one outlet port 104.

In the illustrated embodiment, the ports 104, 106 are pipe stubs suitable for attaching sections of pipe. For example, the diverter valve 100 is fabricated of polyvinyl chloride (PVC) material and additional pipe sections are fused to the ports 104, 106 to form a waterproof, sealed connection. In other embodiments, the ports 104, 106 have flanges and/or threaded connections for attaching piping.

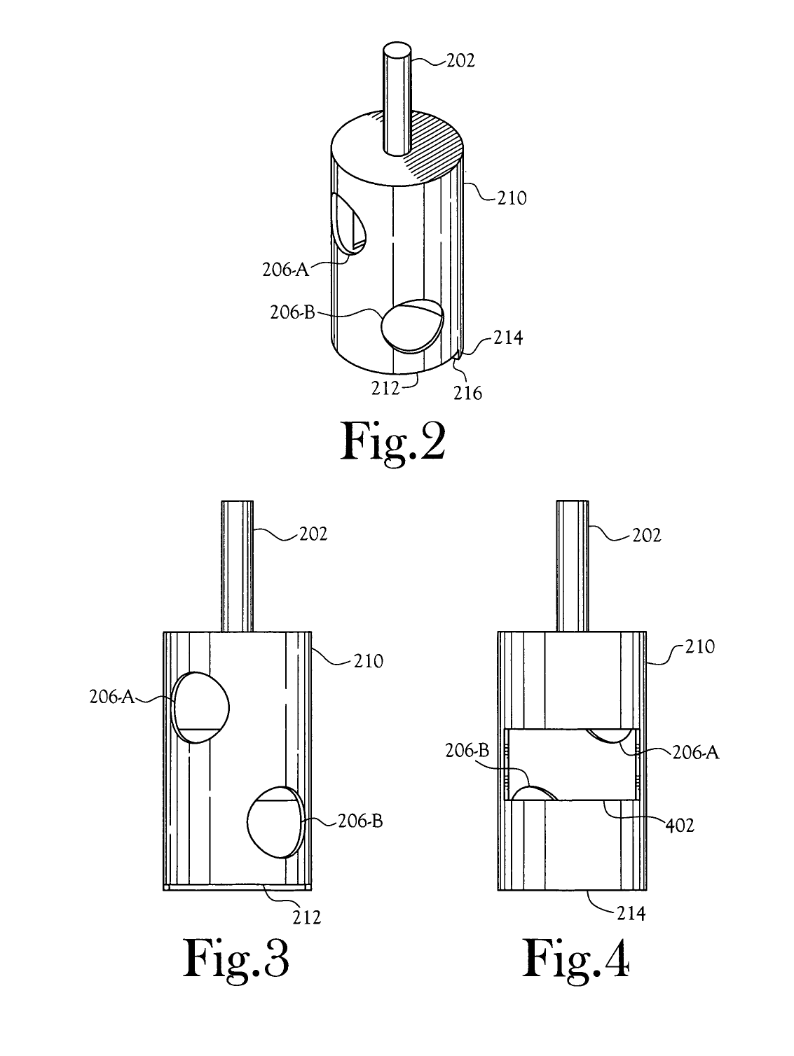

FIG. 2 illustrates a perspective view of one embodiment of a diverter member 210. FIG. 3 illustrates a front view of one embodiment of the diverter member 210 showing a pair of round openings 206-A, 206-B. FIG. 4 illustrates a rear view of one embodiment of the diverter member 210 showing a rectangular opening 402.

The diverter member 210 is a cylinder with a shaft 202 at one end. The diverter member 210 is adapted to rotate about its longitudinal axis within the valve body 102 when the shaft 202 is rotated. The diverter member 210 has an upper bottom edge 212 and a lower bottom edge 214. A flat surface 216 connects the upper and lower bottom edges 212, 214.

The diverter member 210 is hollow and includes a pair of round openings 206-A, 206-B positioned to align with respective ones of the ports 106-A, 106-B as the diverter member 210 rotates within the valve body 102. Opposite the round openings 206 is a rectangular opening 402 positioned to align with the single port 104.

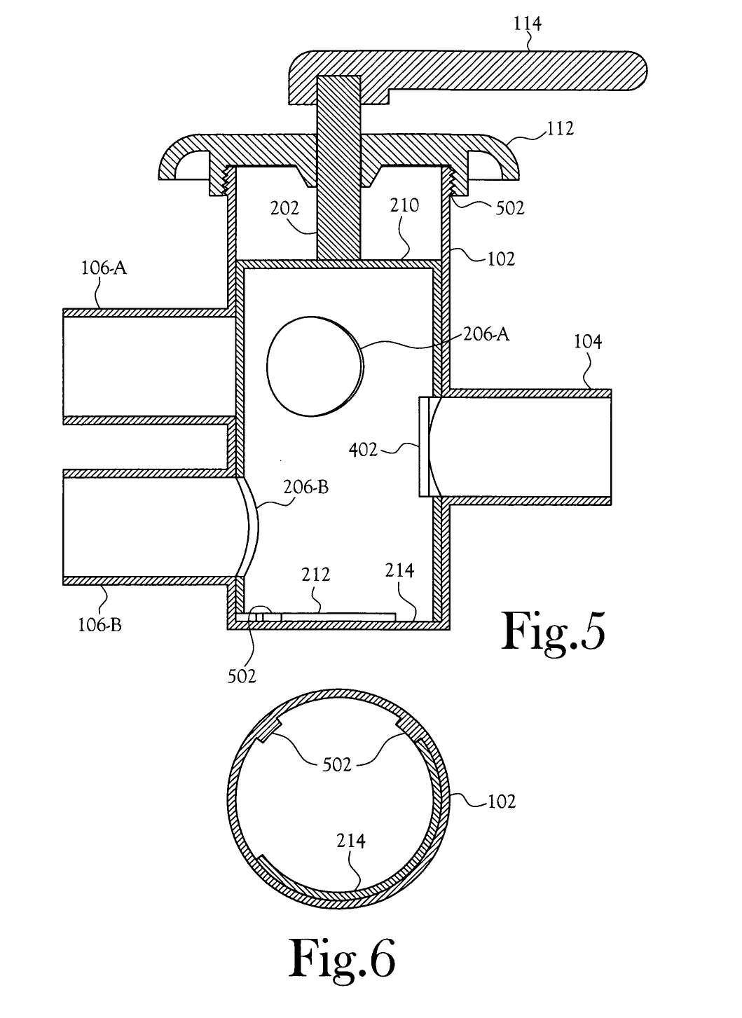

FIG. 5 illustrates a cross-sectional view of one embodiment of the diverter valve 100. The diverter member 210 is shown inside the valve body 102. The valve body 102 is generally cylindrical with a closed bottom. The diverter member 210 slides into the valve body 102 and the valve body 102 is sealed with a cap 112 that has threads 502 that engage the valve body 102. The shaft 202 of the diverter member 210 is connected to a handle 114. In the illustrated embodiment, the handle 114 is the operator that rotates, or moves, the diverter member 210 so as to direct the fluid flow between the single port 104 and one of the dual ports 106. In other embodiments, the operator is a motor or other driving mechanism that provides rotary motion of the shaft 202.

Those skilled in the art will recognize that a fluid seal must be maintained between the valve body 102, the diverter member shaft 202, and the cap 112. In various embodiments, o-rings and other sealing mechanisms are employed to achieve such a seal.

The valve body 102 is substantially cylindrical. In the illustrated embodiment, the first port 104 is positioned diametrically opposite the second and third ports 106-A, 106-B, which allows the fluid to flow in as nearly a straight line as possible between the first port 104 and the second and third ports 106-A, 106-B. The valve body 102 has a cap 112 and a operator, or handle, 114 for positioning the diverter member 210 for diverting the flow between the single port 104 and the dual ports 106. In the illustrated embodiment, the valve body 102 is adapted to receive the diverter member 210, and the opening is sealed with the cap 112.

FIG. 6 illustrates a cross-sectional view of the bottom of the diverter valve 100 showing the lower bottom edge 214 of the diverter member 210 and the stops 502. The inside bottom of the valve body 102 includes stops 502 that prevent the diverter member 210 from rotating beyond a certain point. The stops 502 allow the upper bottom edge 212 of the diverter member 210 to freely move over the stop 502. The stops 502 prevent the diverter member 210 from rotating past the point where the flat surface 216 adjacent the lower bottom edge 214 of the diverter member 210 contacts the stops 502. In the illustrated embodiment, two stops 502 are shown. In another embodiment, a single stop 502 extends from the positions of the two illustrated stops 502.

The diverter valve 100, in the illustrated embodiment, is a two-position valve. In the first position with the flat surface 216 adjacent one of the stops 512, one of the pair of round openings 206-A is aligned with a corresponding one of the pair of ports 106-A. In the second position with the opposite flat surface 216 adjacent the other one of the stops 512, the other one of the pair of round openings 206-B is aligned with a corresponding one of the pair of ports 106-B. In both positions, the rectangular opening 402 is adjacent the single port 104, allowing fluid communication between the port 104 and the inside of the diverter member 210 with the valve 100 at both the first and second positions.

In the embodiment in which the single port 104 is the inlet port, the diverter member 210 is self-sealing because the fluid entering the single port 104 exerts a force against the inside wall of the diverter member 210 adjacent the pair of ports 106, which are the outlet ports. The force exerted against the diverter member 210 forces the diverter member 210 against the inside surface of the valve body 102 adjacent the outlet ports 106, thereby sealing the port 106 that is not aligned with one of the pair of openings 206.

In the illustrated embodiment, the pair of round openings 206 are positioned relative to each other such that as the valve handle 114 is positioned at the extreme ends of its travel, fluid flows through only one of the pair of ports 106. In this embodiment, when the valve handle 114 is in the mid-position, or between the two extreme positions, the diverter member 210 allows fluid to flow through both of the pair of ports 106. In one embodiment, the pair of round openings 206 are positioned closer to each other such that the openings 206 overlap when viewed vertically. In this embodiment, when the valve handle 114 is in either of the extreme positions, fluid flows primarily through one port 106 with limited flow through the other port 106 because a portion of each opening 206 coincides with the inside of the corresponding port 106. Fluid flow though the valve 100 is not totally restricted at any position of the diverter member 210 relative to the valve body 102. By not restricting fluid flow at any position, backpressure to the pump is minimized. One skilled in the art will recognize that the relative positioning and the shape of the pair of openings 206 can vary to achieve a desired flow configuration between the single port 104 and the pair of ports 106 without departing from the spirit and scope of the present invention.

Although the illustrated embodiment shows a single port 104 and a pair of ports 106 cooperating with one diverter member 210, in another embodiment, the valve body 102 is extended with an elongated diverter member 210 such that the valve 100 is a ganged two-position valve 100. That is, the ganged valve has two single ports 104 and two pairs of ports 106 that are cooperatively switched through a single operator 114. In another embodiment, two valve bodies 102 have each of their diverter members 210 operatively connected to form a ganged two-position valve 100.

Various components of the diverter valve 100 perform various functions. The function of sealing the diverter member 210 in the valve body 102 is implemented, in one embodiment, by the cap 112 that fits over the opening in the valve body 102 that receives the diverter member 210. In one embodiment, an o-ring is also used to ensure the cap 112 is sealed when attached to the valve body 102.

The function of preventing the diverter member 210 from rotating beyond the first position and the second position is implemented, in one embodiment, by the one or more stops 502 in the valve body 102 interacting with the lower bottom edge 214 of the diverter member 210.

The function of rotating the diverter member 210 between the first and second positions is implemented, in one embodiment, by the shaft 202 connected to the diverter member 210. In various embodiments, the shaft 202 is rotated by a handle 114 or other mechanism with controlled rotary motion.

From the foregoing description, it will be recognized by those skilled in the art that a diverter valve 100 has been provided. The valve 100 includes a diverter member 210 with three openings 206, 402 allowing passage of fluid. A rectangular opening 402 is positioned and sized such that a passageway between a single port 104 and the inside of the diverter member 210 is assured regardless of the operating position of the diverter member 210. The two round openings 206-A, 206-B are positioned and sized such that, with the diverter member 210 in one position, one opening 206-A is aligned with one of the dual ports 106-A, and with the diverter member 210 in a second position, the other opening 206-B is aligned with the other one of the dual ports 106-B.

The configuration of the first port 104 and the second and third ports 106 reduces the noise of the fluid flowing through the valve 100 because the fluid flows in substantially a straight line with no abrupt 90 degree turns. Further, the pressure drop through the valve 100 is reduced over the prior art valves because the fluid path is substantially straight without any 90 degree bends or turns. Also, the reliability of the valve 100 is increased because the fluid flowing through the valve does not impinge upon the cap 114 or any other sealing mechanism, thereby reducing the potential for leakage.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for diverting fluid flow between a single port and two other ports, said apparatus comprising:
a valve body having a first port, a second port, and a third port, said first port positioned substantially diametrically opposite said second and third ports, said second port positioned substantially parallel to said third port;
a diverter member having a first aperture, a second aperture, and a third aperture, said diverter member being substantially cylindrical shaped, said diverter member rotatable within said valve body between a first position and a second position, said first aperture adjacent said first port with said diverter member in said first position and in said second position, when said diverter member is in said first position, said second aperture is adjacent said second port and said third port is blocked by said diverter member, when said diverter member is in said second position, said third aperture is adjacent said third port and said second port is blocked by said diverter member,
a shaft connected to said diverter member, said shaft extending outside said valve body whereby rotation of said shaft moves said diverter member between said first position and said second position.

2. The apparatus of claim 1 wherein said valve body includes a cylindrical cavity for receiving said diverter member, said apparatus further including a cap for sealing said diverter member in said valve body.

3. The apparatus of claim 1 further including a means for sealing said diverter member in said valve body.

4. The apparatus of claim 1 further including a means for preventing said diverter member from rotating beyond said first position and said second position.

5. The apparatus of claim 1 wherein said valve body includes at least one stop and said diverter member includes at least one surface that engages said at least one stop when said diverter member is at said first position and said second position.

6. The apparatus of claim 1 wherein with said diverter member positioned between said first position and said second position, a portion of said second aperture is adjacent said second port and a portion of said third aperture is adjacent said third port whereby a fluid is capable of flowing between said first port and said second and third ports.

7. An apparatus for diverting fluid flow between a single port and two other ports, said apparatus comprising:
a valve body having a first port, a second port, and a third port, said first port positioned substantially diametrically opposite said second and third ports, said second port having a longitudinal axis substantially parallel to a longitudinal axis of said third port;
a diverter member having a first aperture and a second aperture, said diverter member being substantially cylindrical shaped, said diverter member rotatable within said valve body between a first position and a second position, with said diverter member in said first position, said first aperture is adjacent said second port and said third port is blocked by said diverter member, with said diverter member in said second position, said second aperture is adjacent said third port and said second port is blocked by said diverter member,
a means for rotating said diverter member between said first and second positions.

8. The apparatus of claim 7 wherein said means for rotating includes a shaft connected to said diverter member, said shaft extending outside said valve body whereby rotation of said shaft moves said diverter member between said first position and said second position.

9. The apparatus of claim 7 wherein said valve body includes a cylindrical cavity for receiving said diverter member, said apparatus further including a cap for sealing said diverter member in said valve body.

10. The apparatus of claim 7 further including a means for sealing said diverter member in said valve body.

11. The apparatus of claim 7 further including a means for preventing said diverter member from rotating beyond said first position and said second position.

12. The apparatus of claim 7 wherein said valve body includes at least one stop and said diverter member includes at least one surface that engages said at least one stop when said diverter member is at said first position and said second position.

13. The apparatus of claim 7 wherein with said diverter member positioned between said first position and said second position, a portion of said first aperture is adjacent said second port and a portion of said second aperture is adjacent said third port whereby a fluid is capable of flowing between said first port and said second and third ports.

14. An apparatus for diverting fluid flow between a single port and two other ports, said apparatus comprising:
a valve body having a first port, a second port, and a third port, said first port positioned substantially diametrically opposite said second and third ports;
a diverter member having a first aperture and a second aperture, said diverter member movable within said valve body between a first position and a second position, with said diverter member in said first position, said first aperture is adjacent said second port and said first port is in fluid communication with said second port, with said diverter member in said second position, said second aperture is adjacent said third port and said first port is in fluid communication with said third port; and
an operator for moving said diverter member between said first position and said second position.

15. The apparatus of claim 14 wherein said operator includes a shaft connected to said diverter member, said shaft extending outside said valve body whereby rotation of said shaft moves said diverter member between said first position and said second position.

16. The apparatus of claim 14 further including a cap for sealing said diverter member in said valve body.

17. The apparatus of claim 14 further including a means for sealing said diverter member in said valve body.

18. The apparatus of claim 14 further including a means for preventing said diverter member from rotating beyond said first position and said second position.

19. The apparatus of claim 14 wherein said valve body includes at least one stop and said diverter member includes at least one surface that engages said at least one stop when said diverter member is at said first position and said second position.

20. The apparatus of claim 14 wherein with said diverter member positioned between said first position and said second position, a portion of said first aperture is adjacent said second port and a portion of said second aperture is adjacent said third port whereby a fluid is capable of flowing between said first port and said second and third ports.
